(19) United States
(12) Patent Application Publication
(10) Pub. No.: US 2025/0204572 A1
(43) Pub. Date: Jun. 26, 2025

(54) METHOD AND APPARATUS FOR MAKING A STUFFED MASHED POTATO BALL

(71) Applicant: Michael Kreinest, Jacksonville, FL (US)

(72) Inventor: Michael Kreinest, Jacksonville, FL (US)

(21) Appl. No.: 18/989,109

(22) Filed: Dec. 20, 2024

Related U.S. Application Data
(60) Provisional application No. 63/613,061, filed on Dec. 20, 2023.

(51) Int. Cl. A23P 30/10

(52) U.S. Cl. CPC A23P 30/10

(57) ABSTRACT

A method is disclosed for creating a composite food product using a mold. The method involves placing a first comestible into the mold cavity to create a shaped first comestible. The shaped first comestible is then removed from the mold. Subsequently, a first portion of a second comestible is formed, followed by the formation of a second portion of the second comestible. The first comestible is positioned between the first surface of the first portion of the second comestible and the first surface of the second portion of the second comestible. Finally, optionally a sealing layer is applied to the second surface of the first portion of the second comestible and the second surface of the second portion of the second comestible. This method allows for the creation of visually appealing and delicious composite food products.

This application claims priority under 35 USC 119(e) to U.S. Provisional Application No. 63/613,061 filed Dec. 20, 2023, which is incorporated by reference in its entirety.

### FIELD OF THE EMBODIMENTS

The field of the embodiments of the present invention relate to systems and methods producing a shaped mashed or ground food with liquid, semi-liquid, or solid filling sealed inside.

### BACKGROUND OF THE EMBODIMENTS

The production of shaped food items with enclosed fillings involves intricate methods tailored to manipulate food materials. These techniques integrate a variety of approaches, such as molding or forming processes where a specific food material is shaped and filled before closure. Extrusion technology is utilized to combine food material and fillings, forming shapes that are then sectioned into desired sizes, commonly observed in filled pasta or snack production. Spherification, a method rooted in molecular gastronomy, encompasses the creation of small filled spheres through the reaction of gelling agents with liquid fillings in a setting solution. Injection molding, another technique, involves specialized equipment to infuse fillings into food materials for producing filled bakery goods or pastries. Additionally, freeze-drying or freeze-encapsulation methods employ freezing and dehydration processes to encapsulate fillings within food matrices, preserving the integrity of the product. These sophisticated methods are instrumental in the food industry, yielding diverse, visually appealing, and textured food products with varying fillings enclosed within their structures.

Previous approaches for creating shaped comestibles or edible, consumable food items have involved using molds to shape individual comestibles. These molds typically have a cavity that is filled with a comestible material, such as chocolate or candy, which is then allowed to set or harden to form the desired shape. Once the comestible has hardened, it is removed from the mold to be consumed or further processed. In some cases, multiple portions of a comestible are formed separately and then combined to create a layered or filled comestible. For example, one portion of the comestible may be formed in a mold, removed from the mold, and then another portion of the comestible is formed separately. The two portions are then assembled together to create the final product. Additionally, sealing layers may be used to enclose or protect the comestible. These sealing layers can be applied to the surfaces of the comestible to prevent moisture or other contaminants from affecting the quality or taste of the comestible.

However, none of these approaches have provided a comprehensive solution that combines the features described in this disclosure. The present invention and its embodiments meets and exceeds these objectives. Various systems and methodologies are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

In general, the present invention and its embodiments provide for a method for creating shaped comestibles that involves forming separate portions of a comestible, assembling them together with a first comestible, and applying a sealing layer to enclose the comestible. This method allows for the creation of unique and visually appealing comestibles with a variety of flavors and textures.

In some aspects, the techniques described herein relate to a method including: providing a mold, the mold having a cavity; disposing a first comestible within the cavity of the mold to form a shaped first comestible; removing the shaped first comestible from the cavity of the mold; forming a first portion of a second comestible; forming a second portion of a second comestible; disposing the first comestible between a first surface of the first portion of the second comestible and a first surface of the second portion of the second comestible; and disposing a sealing layer at a second surface of the first portion of the second comestible and a second surface of the second portion of the second comestible.

In some aspects, the techniques described herein relate to a method further including: freezing the shaped first comestible.

In some aspects, the techniques described herein relate to a method further including: forming a first recess in the first surface of the first portion of the second comestible and a second recess in the second surface of the second portion of the second comestible; and retaining the first comestible within the first recess of the first portion of the second comestible and the second recess of the second portion of the second comestible.

### BRIEF DESCRIPTION OF THE DRAWINGS

FIG. 1A is a flowchart illustrating a method, according to some embodiments of the present disclosure.

FIG. 1B is a flowchart extending from FIG. 1A and further illustrating the method, according to some embodiments of the present disclosure.

FIG. 2 is a flowchart further illustrating the method from FIG. 1A, according to some embodiments of the present disclosure.

FIG. 3 illustrates a first comestible disposed within a cavity of a mold, according to some embodiments of the present disclosure.

FIG. 4 illustrates forming a first portion of a second comestible and forming a second portion of a second comestible, according to some embodiments of the present disclosure.

FIG. 5 illustrates forming a first recess in the first surface of the first portion of the second comestible and a second recess in the second surface of the second portion of the second comestible, according to some embodiments of the present disclosure.

FIG. 6 illustrates disposing a sealing layer at a second surface of the first portion of the second comestible and a second surface of the second portion of the second comestible, according to some embodiments of the present disclosure.

FIG. 7 illustrates a comestible product formed by a method, according to some embodiments of the present disclosure.

FIG. 8 illustrates one embodiment showing the various molds to make the edible comestible product of the present invention.

FIG. 9 illustrates how the smaller mold can be put together to make a first comestible.

FIG. 10 illustrates the opening of the smaller mold to reveal the first comestible.

FIG. 11 illustrates the smaller mold being completely open revealing the various first comestibles.

FIG. 12 illustrates the larger mold with the second comestible.

FIG. 13 illustrates the first comestible being inserted into the center of one portion of the second comestible.

FIG. 14 illustrates the two sides of the larger mold being placed together to allow the second comestible to encompass the first comestible.

FIG. 15 illustrates the larger mold being opened to reveal a product that has the second comestible encompassing the first comestible.

FIG. 16 illustrates the product that is ready for further processing with the product being covered with flour and/or other ingredients.

FIG. 17 illustrates the product that has been cooked.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

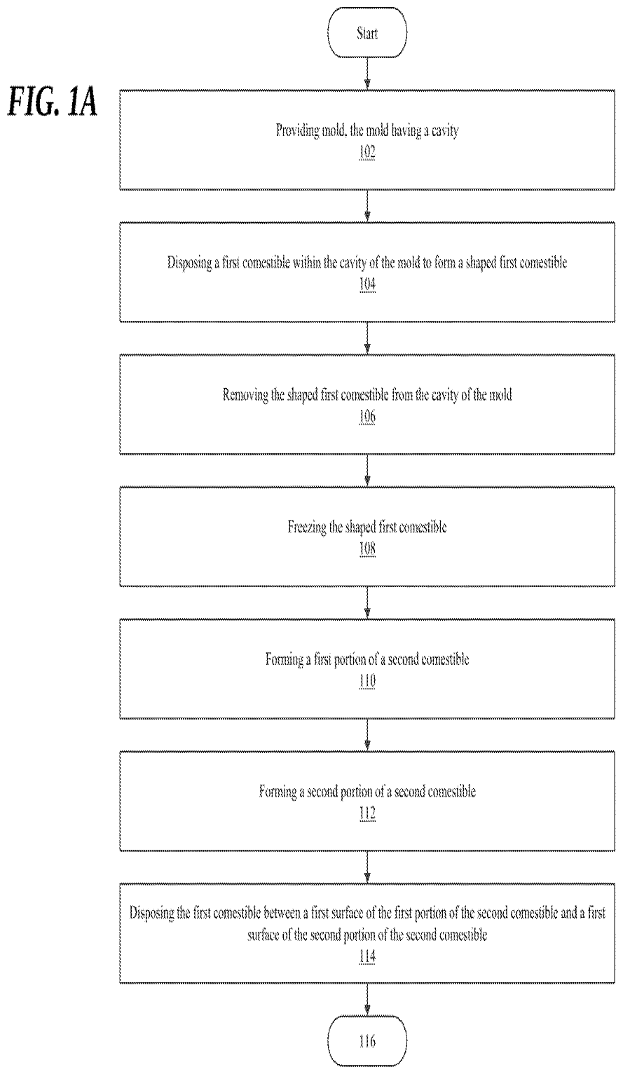

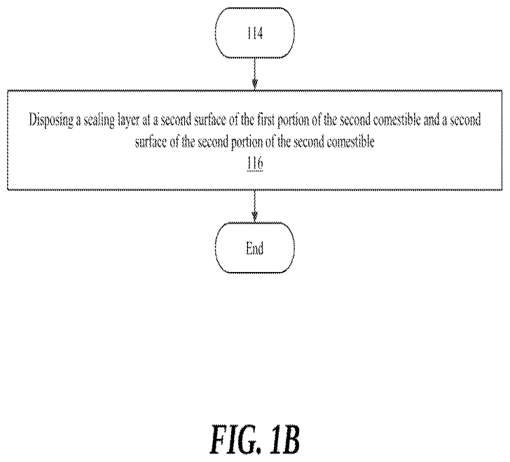

FIGS. 1A to 1B are flowcharts that describe a method, according to some embodiments of the present disclosure. In some embodiments, at 102, the method may include providing mold, the mold having a cavity. At 104, the method may include disposing a first comestible within the cavity of the mold to form a shaped first comestible. At 106, the method may include removing the shaped first comestible from the cavity of the mold. At 108, the method may include freezing the shaped first comestible. At 110, the method may include forming a first portion of a second comestible. In some embodiments, at 112, the method may include forming a second portion of a second comestible. At 114, the method may include disposing the first comestible between a first surface of the first portion of the second comestible and a first surface of the second portion of the second comestible. At 116, the method may include disposing a sealing layer at a second surface of the first portion of the second comestible and a second surface of the second portion of the second comestible.

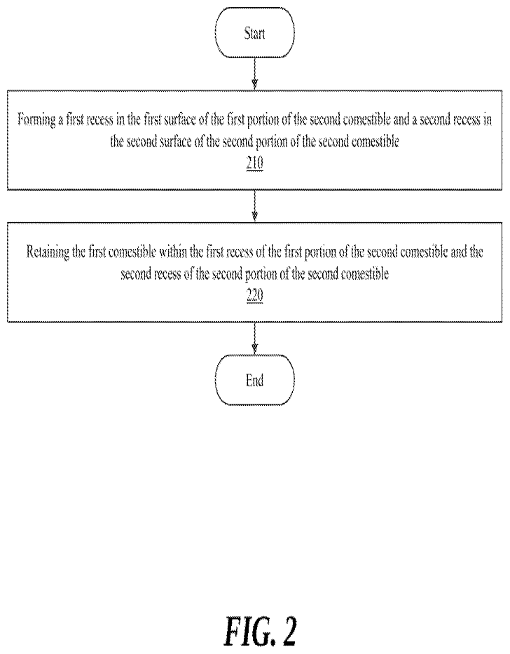

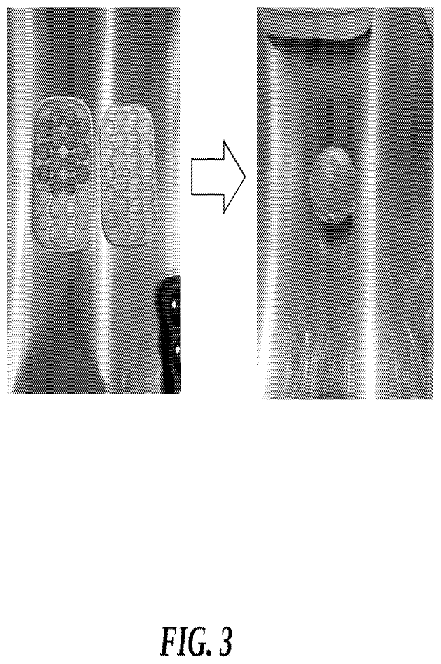

FIG. 2 is a flowchart that further describes the method from FIG. 1A, according to some embodiments of the present disclosure. In some embodiments, at 210, the method may include forming a first recess in the first surface of the first portion of the second comestible and a second recess in the second surface of the second portion of the second comestible. At 220, the method may include retaining the first comestible within the first recess of the first portion of the second comestible and the second recess of the second portion of the second comestible. FIGS. 3-5 illustrate a comestible product produced using the method of FIGS. 1A, 1B, and 2.

FIG. 3 shows a comestible product formed from methods of FIGS. 1A, 1B, and 2 for producing shaped (e.g. spheres) mashed or ground food (e.g. potato) with liquid, semi-liquid, or solid filling sealed inside. The following examples illustrate a manual process for ease of description with readily available implements to produce the comestible product. It is intended that much of this process will be automated at scale. In an embodiment, filling the mashed food shapes prior to cooking may be implemented. In a first step of this process, the fillings may be shapes and solidified. Fill shaped ice molds (e.g. spherical) with the intended precooked/pasteurized filling or sauce (e.g. turkey gravy, tomato ketchup, etc.) proportionate to the amount and shape of the mashed food it will complement to achieve the desired ratio (e.g. mashed potato to gravy) per bite. The filling may be frozen. The freezing process and temperature varies depending on the filling used.

Sugary fillings, like ketchup, require colder set temperatures to achieve a workable solid texture, while some dairy based fillings like sour cream, require fast drops in temperature to avoid excessive ice crystal formation. Some fillings that are already solid at room or refrigerated temperature (e.g. cheese, butter) require no freezing (just shaping).

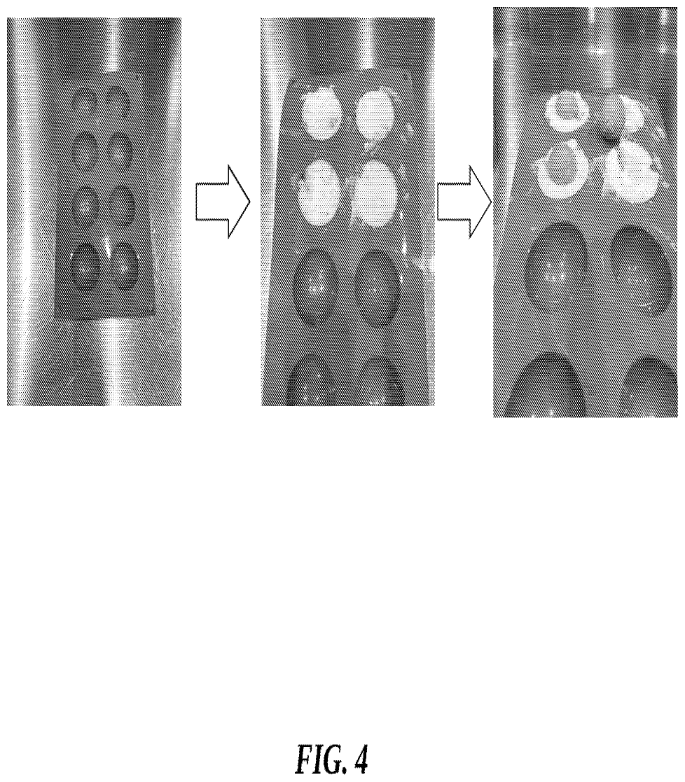

FIG. 4 shows a comestible product formed, in part, from a second step, forming two hemispheres of the mashed or ground food being achieved through the utilization of a mold or a mechanical scoop/form, designed to replicate the shape of the filling form. Step three involves inserting the frozen or formed filling halfway into one of the hemispheres.

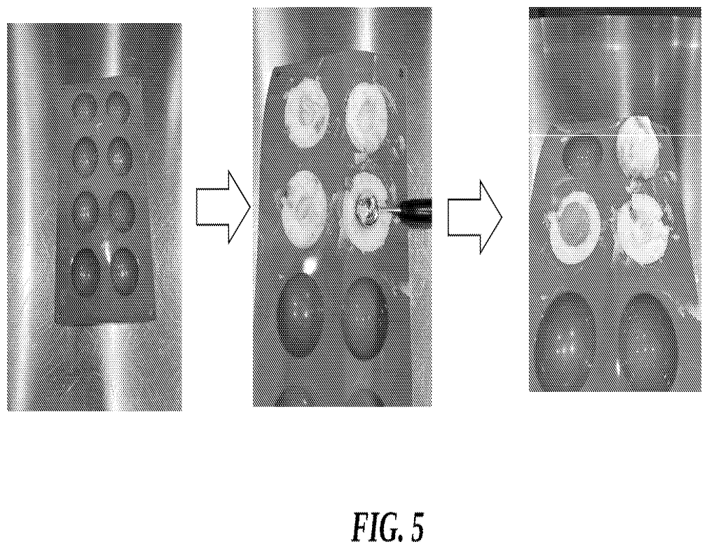

FIG. 5 shows a comestible product formed, in part, from by an alternative to steps of FIG. 4 in which an indentation may be created in each hemisphere of the mashed or ground food using a solid implement that replicates the shape of the filling. This process ensures a more uniform and centralized pocket for the filling concerning the exterior of the shaped food. Step four entails the application of the second hemisphere to the first, thereby completing the formation of a cohesive shape.

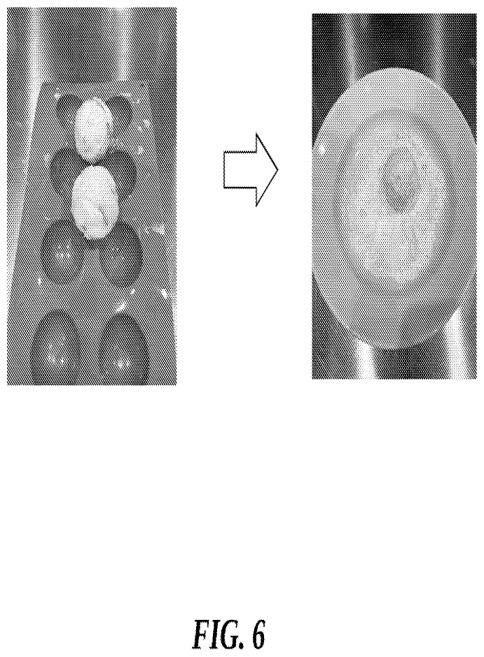

FIG. 6 shows a comestible product formed, in part, from step five in which the exterior of the shaped product is sealed by creating a “crust” using a combination of ingredients that adhere to the exterior of the shape. These adhering ingredients can be cooked or dried onto the surface, examples of which include batter, powder coatings, or solidifying dipped coatings.

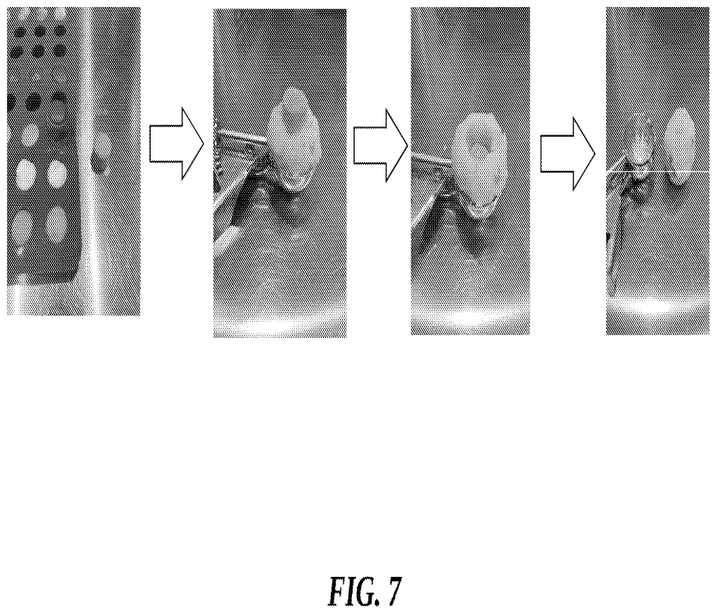

FIG. 7 shows an alternative method of forming a comestible product. In the first step of the process, the filling is shaped into a solid form. Moving to the second step, a partial sphere mold or a scoop larger than half a sphere is used to create a rounded scoop. Subsequently, in the third step, the shaped filling is placed into the center of the mounded food mash, causing the food material to rise around the edges of the mold, encapsulating the filling. The filling is fully enclosed by applying downward pressure, ensuring that the food mash covers it entirely. Finally, the fourth step involves sealing the exterior shape of the food item as described in FIG. 6.

In an embodiment, the filling is put into a mold and frozen (the mold can be a one-piece mold or a two-piece mold). The filling is removed from the mold after freezing. The filling can be formed into either a single full sphere or two hemispheres for the process (wherein the two hemispheres are combined). In certain embodiments, there are some fillings (e.g., butter and cheese) that display sufficiently solid-like tendencies that they do not need to be frozen. Rather, they can be formed into a spherical shape (or any other desired shape) without freezing in the mold. Rather, they can be cooled to a temperature that is generally below room temperature.

In an embodiment, a potato (assuming comestible 2) can be inserted into larger hemispheric molds.

It should be understood that depending on the food product that is used, it may not be necessary to form an indentation as discussed and disclosed in FIG. 5. For example, it is not necessary to form an indentation in a potato as depressing a frozen (or solid) filling into a potato is usually sufficient to allow it to be inserted as a filling into the food product and the formation of an indentation is unnecessary because the act of insertion creates an indentation.

In an embodiment, if a potato is used, two hemisphere molds of the potato can be put together. In a variation, the filling can be inserted in a number of ways, two of which include using either a whole sphere filling and inserting it in one side or alternatively, half filling hemispheres in both sides of the potato molds. Subsequently, the potato molds can be closed. Generally, the two halves of the potato mold will seal together in the mold when closed, therefor casting a ball-like food product. Subsequently, the whole sphere can be removed from the mold with the spherical food product containing the filling inside.

It is at this point that the ball-like food product can be coated and/or battered. In a variation, the battered balls can be frozen for frying or cooking later, or alternatively, they can be fried or cooked immediately.

The comestible can be par fried (usually just long enough to cook the outer coating) and the comestible can be re-frozen, ready to be used as a fully cooked comestible. The comestible can be heated and serve as frozen food product (oven, air frier or microwave). We skip the par-frying step for commercial customers who will receive them frozen as is and ready for the deep frier before serving (similar to frozen, fried food products like french fries). If they are serving them in their restaurant, the cooking of the outer coating and the heating of the entire ball (melting the liquid filling) is done in one step.

### Example

Mashfulls are formed mashed potatoes with a crispy coating and a sauce/condiment/comestible filled center.

Mashfulls can be made in different sizes and shapes. In an embodiment, the ratio of sauce to potato remains roughly consistent. For the purposes of this illustration, the shape of the Mashfull is spherical with the following sizes:
Outside diameter of mashed potato mold (uncoated): 1.78 inches (+/−0.05 inch)
Outside diameter of the inner condiment mold: 0.82 inch (+/−0.07 inch)
Outside of diameter of finished, coated product: 2 inches (+/−0.1 inch)

The method of producing Mashfulls is suited for both manual and automated processes and machinery.

### Procedure for Making a Mashfull:

Prepare filling: Sauces, condiments, gravies, etc. are prepared according to their respective recipes and fully cooked or pasteurized. The sauces are then formed into a ball by one of two methods:
1) Using a mold: fillings are cooled to a workable temperature (below 80 degrees Fahrenheit—26.7° C.) while remaining viscous (either liquid or paste like) and injected into a two piece mold. The molds containing the filling are put into a freezer and frozen solid (freezing temperature may vary slightly depending upon the recipe) and held in a solid state, either inside the mold or removed from the mold as solid spheres.
2) Using a scoop or ball former: the fillings are cooled to a solid but workable state (temperature depending on recipe) and formed into balls using a hemisphere scoop or baller, then frozen completely solid (the temperature may vary slightly depending on the recipe) and held in a frozen state.

### Preparing the Mashed Potatoes:

Potatoes are steamed or boiled for 23 to 30 minutes (depending on their size with larger potatos requiring longer cooking times). The potatoes can be skinned prior to or after steaming.

The potatoes are mashed using downward pressure with a mashing device leaving small (approximately 0.33 inch (˜0.84 cms)) chunks. The mashed potatoes are seasoned according to the recipe (e.g., salt, pepper, garlic, etc.) and cooled to 70 degrees Fahrenheit (21.1° C.) or below.

The mashed potatoes are formed into hemispheres (half of the final shape) using a spherical mold. Approximately 1 OZ (˜28 grams) of mashed fill a single hemisphere (either a single mechanical metal mold/scoop or silicon mold).

### Preparing the Final Product:

The frozen filling is placed halfway into each mashed potato hemisphere while still in the hemisphere mold. The second mashed potato hemisphere (also still in the hemisphere mold) is placed on top of the first mashed potato hemisphere and pressed together forming a complete spherical shape (sphere). The sphere is subsequently ejected from the mold.

The spheres are coated with potato starch, dunked or sprayed with liquid batter, coated with Panko bread crumbs, and then finally dusted with semolina flour. The battered and coated spheres are frozen.

After freezing, the product can be par fried and re-refrozen for consumers wishing to heat and serve them, or alternatively, they can be delivered without par frying the comestible and delivered frozen to be fully cooked in a frier for food service operations.

In an embodiment, the comestible that is created is a potato mashfull that provides a liquid center (e.g., a sauce) when it is cooked (e.g., the freezing may cause the liquid center to freeze).

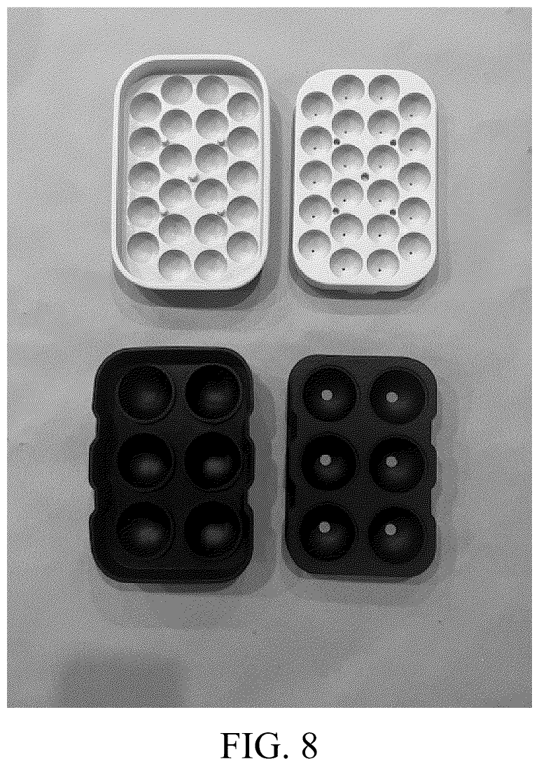

FIGS. 8-17 illustrate the process as described above. For example, FIG. 8 illustrates one embodiment showing the various molds to make the edible comestible product of the present invention. It should be noted that one of the molds creates a comestible that is slightly smaller than the other allowing the smaller comestible to be inserted into the larger comestible. The smaller mold and the larger mold each have two sides allowing spherical products to be made. It should be understood that although these are shown as being able to generate spherical products, other product shapes can be created by varying the mold.

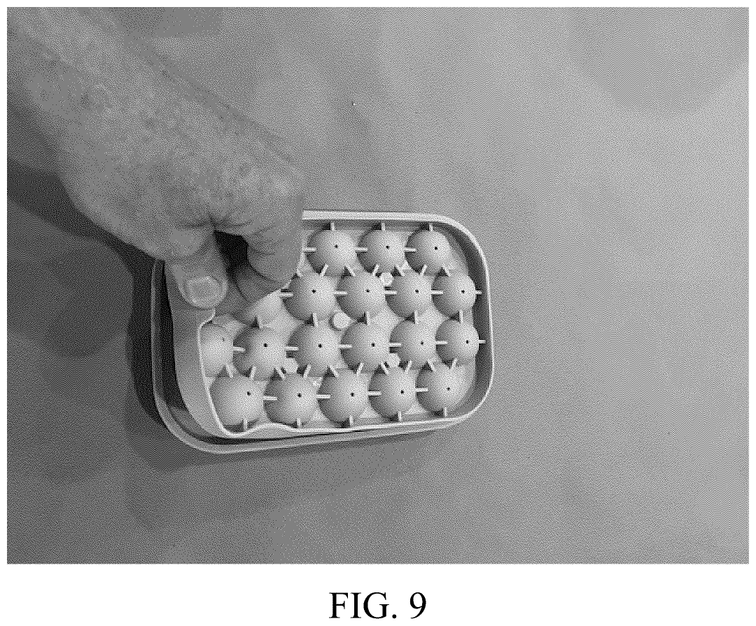

FIG. 9 illustrates how the smaller mold can be put together to make a first comestible. The mold sides are designed to accommodate one another so that a relatively tight seal is made between the two sides.

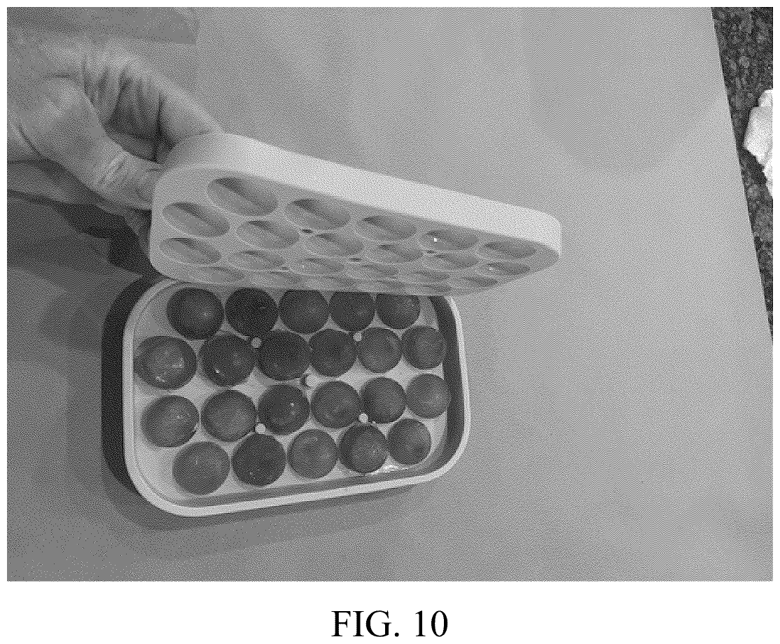

FIG. 10 illustrates opening of the smaller mold to reveal the first comestible. In this case, the first comestible may be a sauce or some liquid that is optionally frozen so that it creates a solid sphere.

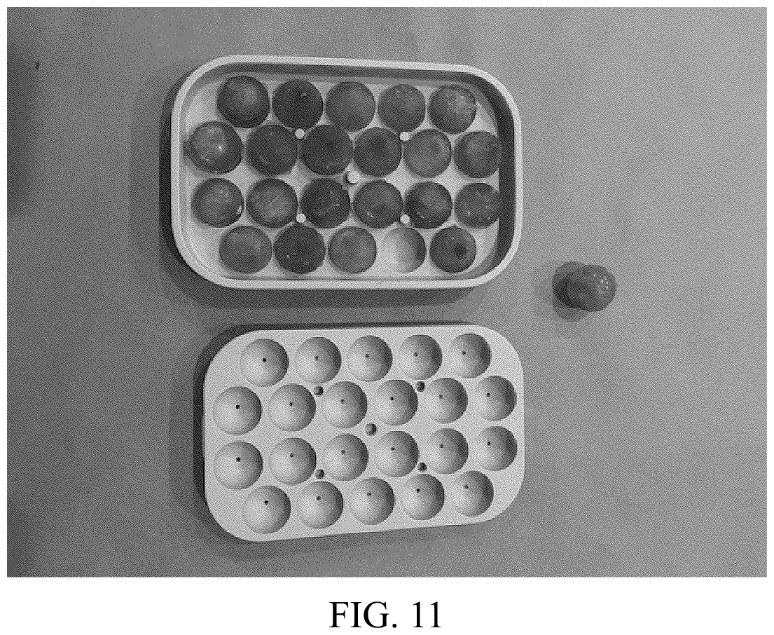

FIG. 11 illustrates the smaller mold being completely open revealing the various first comestibles. The freezing of the first comestible (which may be a liquid at room temperature and atmospheric pressure) creates a solid product allowing it to be inserted into the center of the second comestible.

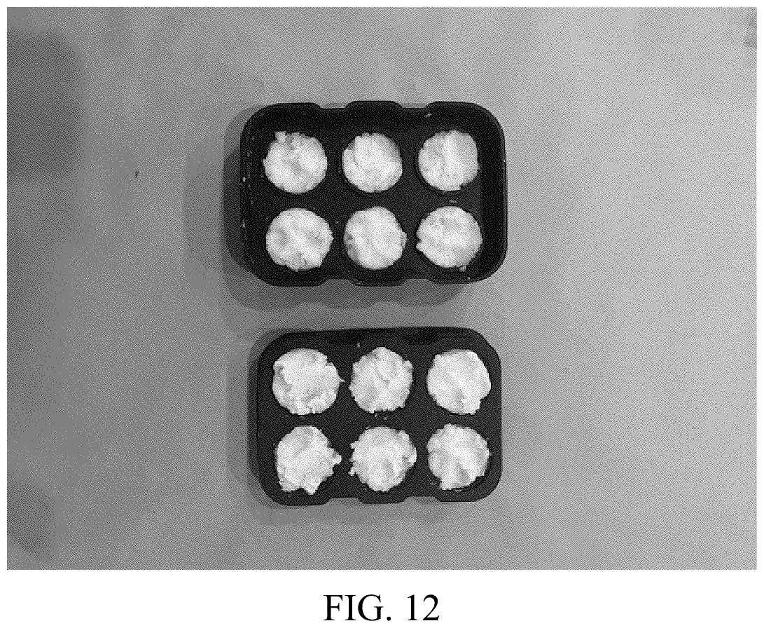

FIG. 12 illustrates the larger mold with the second comestible. In this case, the second comestible may be a potato (which is either mashed and or ground), which is ideally suited to accept the first comestible in the center.

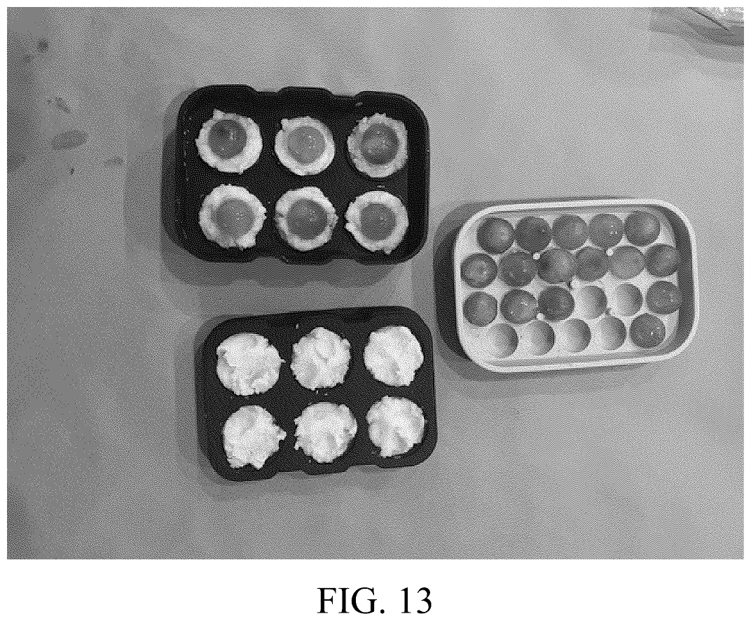

FIG. 13 illustrates the first comestible being inserted into the center of one portion of the second comestible. In this instance, the first comestible sauce is placed into the ground or mashed potato and the act of placing the first comestible into the center of the second comestible causes the edges/sides of the second comestible to rise.

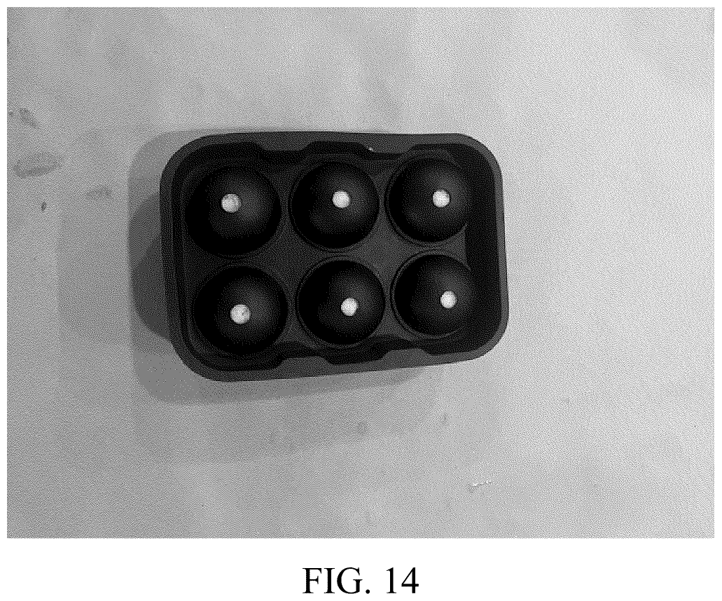

FIG. 14 illustrates the two sides of the larger mold being placed together to allow the second comestible to encompass the first comestible. This figure illustrates that the two half spheres of the second comestible are joined together allowing theme to encompass/enclose the first comestible.

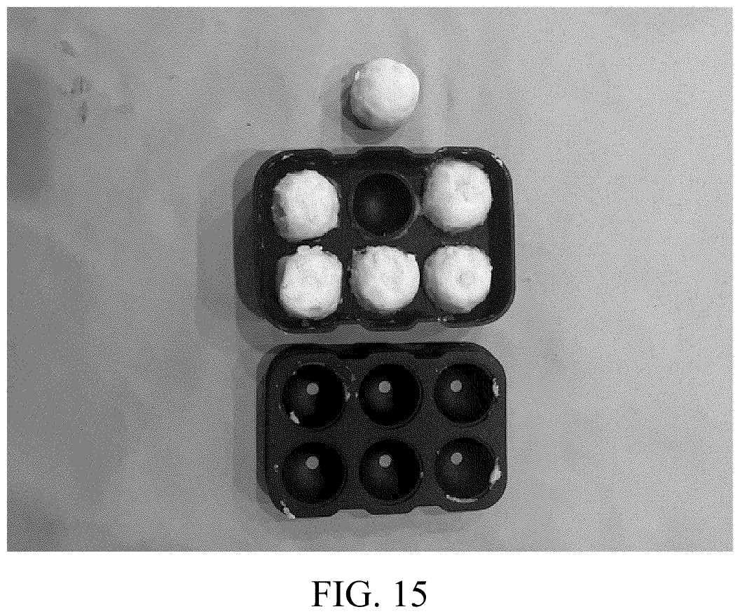

FIG. 15 illustrates the larger mold being opened to reveal a product that has the second comestible encompassing the first comestible. In this instance, the sauce is contained within the potato.

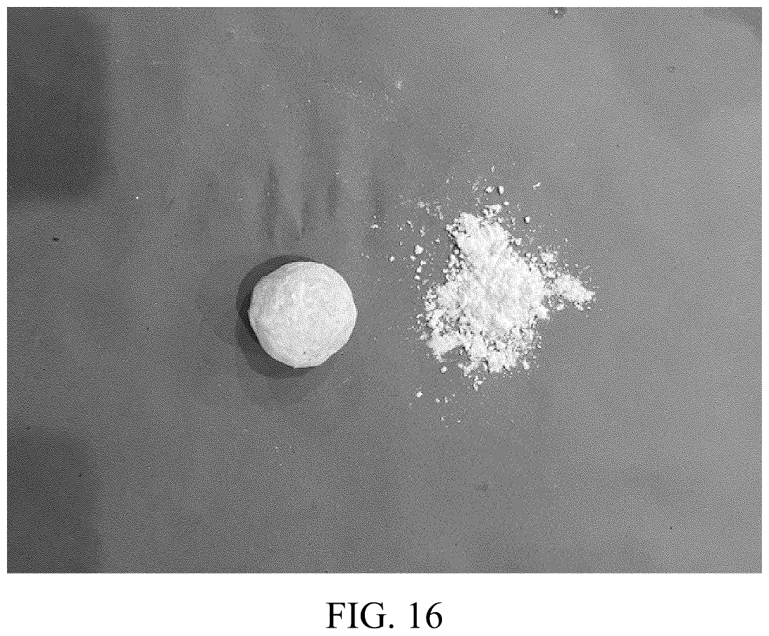

FIG. 16 illustrates the product that is ready for further processing with the product being covered with flour and/or other ingredients. As noted herein, the second comesible spheres are ready for further processing and they may be coated with potato starch, dunked or sprayed with liquid batter, and/or coated with Panko bread crumbs, and optionally finally dusted with semolina flour.

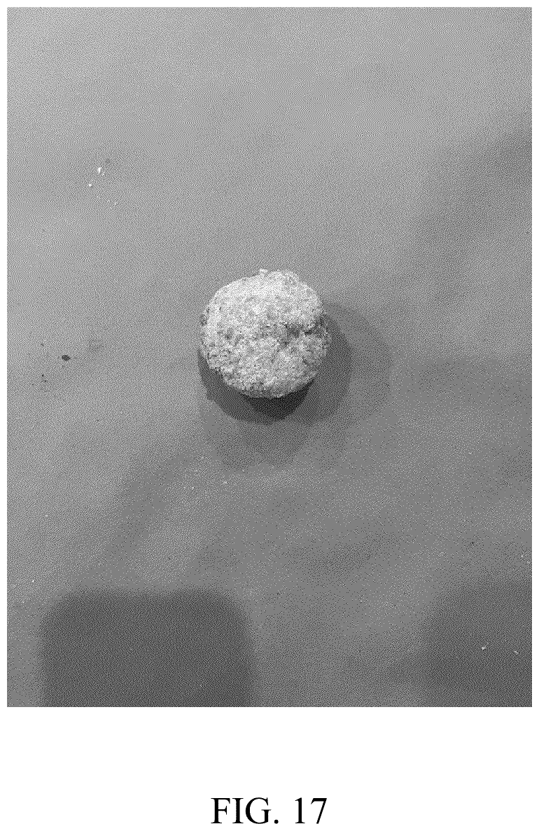

FIG. 17 illustrates the product that has been cooked. It should be understood that either full or partial cooking (e.g., par frying) may occur. In this particular case, the product has been completely cooked and it is ready for eating. The potato is fully cooked and it contains a liquid center (that may be a sauce).

In an embodiment, the present invention relates to comestibles and methods of making these comestibles.

In an embodiment, the present invention relates to a method of making a comestible comprising:
providing a mold, the mold having a cavity;
disposing a first comestible within the cavity of the mold to form a shaped first comestible;
removing the shaped first comestible from the cavity of the mold;
forming a first portion of a second comestible;
forming a second portion of a second comestible;
disposing the first comestible between a first surface of the first portion of the second comestible and a first surface of the second portion of the second comestible;
connecting at least a portion of the first portion of the second comestible to at least a portion of the second portion of the second comestible; and
disposing a sealing layer at a second surface of the first portion of the second comestible and a second surface of the second portion of the second comestible.

In a variation, the first comestible is a liquid at room temperature and atmospheric pressure. The first comestible may be a sauce that is a liquid at room temperature and atmospheric pressure but can be placed in a freezer to freeze the first comestible. In a variation, the mold may be a mold that allows the first comestible to be frozen in a spherical shape. Alternatively, the first comestible may be placed in a mold that when frozen allows the first comestible to be in any shape/form. The frozen first comestible can be manipulated by shaving (or by other means) the frozen first comestible to form any desired shape (e.g., a sphere).

In a variation, the first comestible may be a solid that can be manipulated at room temperature and atmospheric pressure (for example, the first comestible may be a cheese or butter or another product that technically is a solid at room temperature but can be easily shaped as a solid). Alternatively, it should be understood that a temperature and/or a pressure may be modulated so that a first comestible that is a solid at room temperature and atmospheric pressure may become a liquid (e.g., butter becomes a liquid at temperatures slightly about room temperature (around 32-35° C.)) so that it can be easily manipulated to form a given shape (e.g., the butter may be a liquid at a slightly elevated temperature and upon lowering the temperature become a solid). Subjecting butter to very cold temperatures allows the butter to become hard allowing the butter to be treated like a hard solid.

In a variation, the method further comprises freezing the shaped first comestible.

In a variation, the method further comprises forming a first recess in the first surface of the first portion of the second comestible and a second recess in the second surface of the second portion of the second comestible; and retaining the first comestible within the first recess of the first portion of the second comestible and the second recess of the second portion of the second comestible.

In a variation, the first comestible and/or the second comestible comprises a mashed or ground food product. In a variation, the first comestible and/or the second comestible comprises potato. In a variation, a shape of the first comestible and/or the second comestible is/are spherical. In a variation, the sealing layer forms a crust. In a variation, the sealing layer comprises one or more adhering ingredients selected from the group consisting of batter, powder coatings, and solidifying dipped coatings or combinations thereof. In a variation, the adhering ingredients are cooked or dried.

In an embodiment, the present invention relates to a method of forming a comestible product, the method comprising:
procuring a filling, the filling shaped into a solid form to generate a shaped filling,
placing a mashed or a grounded food product into a partial sphere mold or a scoop to generate a semi-spherical food product, wherein the partial sphere mold and the scoop is larger than a half sphere,
adding and pushing down on the shaped filling to a center of the semi-spherical food product causing an edge of the semi-spherical food product to rise encapsulating the shaped filling to generate an encapsulated food product, and optionally sealing the encapsulated food product with a sealing layer.

In a variation, the sealing of the encapsulated food product with the sealing layer is performed. In a variation, the filling comprises liquid, semi-liquid, or solid filling sealed inside the comestible product.

In an embodiment, the present invention relates to a comestible product produced using the method as described above. In a variation, the comestible product is made by a method that further comprises freezing the shaped first comestible. In a variation, the product is made by a method that further comprises forming a first recess in the first surface of the first portion of the second comestible and a second recess in the second surface of the second portion of the second comestible; and retaining the first comestible within the first recess of the first portion of the second comestible and the second recess of the second portion of the second comestible.

In a variation, the first comestible and/or the second comestible comprises a mashed or ground food product. In a variation, the first comestible and/or the second comestible comprises potato. In a variation, a shape of the first comestible and/or the second comestible is/are spherical, and the sealing layer forms a crust.

In a variation, the filling is frozen prior to placing it in the center of the semi-spherical food product. In a variation, sealing of the encapsulated food product with the sealing layer is performed.

Although this invention has been described with a certain degree of particularity, it is to be understood that the present disclosure has been made only by way of illustration and that numerous changes in the details of construction and arrangement of parts may be resorted to without departing from the spirit and the scope of the invention. It should be understood that it is contemplated that the present invention includes the combination of any feature that is disclosed above with any other feature as long as those features are not incompatible. For example, a method step that may be included in a particular method may just as easily be included in a different disclosed method as long as that method step is not incompatible with the different disclosed method. Moreover, the method steps as enumerated herein can be adjusted so that they occur in a different order as long as the comestible product that is desired can be/is made. For example, a freezing step of a partial or complete product may take place in a mold or alternatively, the partial or complete product may be removed from the mold prior to freezing. Accordingly, a method that is disclosed herein can have the method steps practiced in an order that is different from that disclosed.

What is claimed is:

1. A method comprising:
providing a mold, the mold having a cavity;
disposing a first comestible within the cavity of the mold to form a shaped first comestible;
removing the shaped first comestible from the cavity of the mold;
forming a first portion of a second comestible;
forming a second portion of a second comestible;
disposing the first comestible between a first surface of the first portion of the second comestible and a first surface of the second portion of the second comestible;
connecting at least a portion of the first portion of the second comestible to at least a portion of the second portion of the second comestible; and
disposing a sealing layer at a second surface of the first portion of the second comestible and a second surface of the second portion of the second comestible.

2. The method of claim 1 further comprising:
freezing the shaped first comestible.

3. The method of claim 1 further comprising:
forming a first recess in the first surface of the first portion of the second comestible and a second recess in the second surface of the second portion of the second comestible; and
retaining the first comestible within the first recess of the first portion of the second comestible and the second recess of the second portion of the second comestible.

4. The method of claim 1, wherein the first comestible and/or the second comestible comprises a liquid, a mashed or a ground food product.

5. The method of claim 4, wherein the first comestible and/or the second comestible comprises potato or a sauce.

6. The method of claim 4, wherein a shape of the first comestible and/or the second comestible is/are spherical.

7. The method of claim 1, wherein the sealing layer forms a crust.

8. The method of claim 1, wherein the sealing layer comprises one or more adhering ingredients selected from the group consisting of batter, powder coatings, and solidifying dipped coatings.

9. The method of claim 8, wherein the adhering ingredients are cooked or dried.

10. A method of forming a comestible product, the method comprising:
procuring a filling, the filling shaped into a solid form to generate a shaped filling,
placing a mashed or a grounded food product into a partial sphere mold or a scoop to generate a semi-spherical food product, wherein the partial sphere mold and the scoop is larger than a half sphere,
adding and pushing down on the shaped filling to a center of the semi-spherical food product causing an edge of the semi-spherical food product to rise encapsulating the shaped filling to generate an encapsulated food product, and optionally sealing the encapsulated food product with a sealing layer.

11. The method of claim 10, wherein the filling prior to generating the shaped filling is liquid, semi-liquid, or solid.

12. A comestible product produced using the method of claim 1.

13. The comestible product of claim 12, wherein the method further comprises freezing the shaped first comestible.

14. The comestible product of claim 12, wherein the method further comprises:
forming a first recess in the first surface of the first portion of the second comestible and a second recess in the second surface of the second portion of the second comestible; and
retaining the first comestible within the first recess of the first portion of the second comestible and the second recess of the second portion of the second comestible.

15. The comestible product of claim 12, wherein the first comestible and/or the second comestible comprises a mashed or ground food product.

16. The comestible product of claim 15, wherein the first comestible and/or the second comestible comprises potato.

17. The comestible product of claim 12, wherein a shape of the first comestible and/or the second comestible is/are spherical, and wherein the sealing layer forms a crust.

18. A comestible product produced using the method of claim 10.

19. The comestible product of claim 18, wherein the filling is frozen.

20. The comestible product of claim 18, wherein the sealing of the encapsulated food product with the sealing layer is performed.
